(19) United States
(12) Patent Application Publication
(10) Pub. No.: US 2025/0336160 A1
(43) Pub. Date: Oct. 30, 2025

(54) AUGMENTED REALITY VISUALIZATION AND SIZING OF EQUIPMENT WITHIN A SPACE

(71) Applicant: Wolf Apps, LLC, Rockwall, TX (US)

(72) Inventors: Timothy J. Wolf, Rockwall, TX (US); James F. Gero, Rockwall, TX (US)

(21) Appl. No.: 19/189,357

(22) Filed: Apr. 25, 2025

Related U.S. Application Data
(60) Provisional application No. 63/639,078, filed on Apr. 26, 2024.

(51) Int. Cl. G06T 19/00

(52) U.S. Cl. CPC G06T 19/006

(57) ABSTRACT

A user terminal for use with installation sizing may include one or more cameras configured to generate a video feed, a user terminal display configured to display the video feed, and one or more distance sensors configured to generate distance data associated with the video feed. The user terminal may be configured to determine a dimension corresponding to an installation region based at least in part on the distance data, receive an indication of one or more pieces of acceptable equipment based, at least in part, on the determined dimension, and overlay an augmented reality element on the video feed corresponding to at least one piece of the one or more pieces of acceptable equipment.

### CROSS-REFERENCE TO RELATED APPLICATIONS

This application claims the benefit of U.S. Provisional Application Ser. No. 63/639,078 filed on Apr. 26, 2024, entitled Augmented Reality (AR) Assisted Remote Job Consultation Tool, which is fully incorporated herein by reference.

### TECHNICAL FIELD

The present disclosure is generally related determining fitment and/or visualization of equipment within a space and more specifically related to determining fitment and/or visualization of equipment within a space through use of one or more augmented reality elements.

### BACKGROUND INFORMATION

Prior to acquisition of large equipment (e.g., furnishings, appliances, mobility aids such as elevators, and/or the like), it may be desirable to determine whether a space (e.g., a room within a building) is able to accommodate the equipment. In one example, an installation technician may visit the space, obtain measurements of the space, and determine if the equipment is able to received within the space. In this example, a technician is required to physically visit the space, which can be time consuming and inconvenient. In another example, a user of the space (e.g., a property owner) may make measurements within the space. However, the user of the space may not understand how or where the measurements are taken, which may result in inaccurate and/or incomplete measurements being taken. In this example, this may require significant communication between the user of the space and installation technician for the equipment to determine whether the desired equipment is able to be accommodated within the space.

After dimensionally appropriate equipment is selected, it may challenging for a user of the space to visualize the equipment within the space. In some instances, digital mock-ups may be prepared using previously obtained imagery. However, the digital mock-ups may be static and not allow for a user to readily visualize the equipment from different orientations and/or adjust a position or orientation of the equipment within the digital mock-up. Such cases may require the generation of multiple digital mock-ups. Generation of multiple mock-ups may consume significant time and/or resources and one or more (e.g., all) digital mock-ups may not be useful to the user.

### BRIEF DESCRIPTION OF THE DRAWINGS

These and other features and advantages will be better understood by reading the following detailed description, taken together with the drawings, wherein:

FIG. 1 shows a schematic block diagram of an installation sizing system, consistent with embodiments of the present disclosure.

FIG. 2 shows a schematic example of a user terminal for use in the sizing system of FIG. 1, consistent with embodiments of the present disclosure.

FIG. 3 shows a schematic example of the user terminal of FIG. 2 disposed within a room, consistent with embodiments of the present disclosure.

FIG. 4 shows a schematic example of a technician terminal for use in the sizing system of FIG. 1, consistent with embodiments of the present disclosure.

FIG. 5 shows a flow chart of an example method of technician guided dimension gathering, consistent with embodiments of the present disclosure.

FIG. 6 shows a flow chart of an example of sub-steps corresponding to a step of the method of FIG. 5, consistent with embodiments of the present disclosure.

FIG. 7 shows a flow chart of an example method of self-guided dimension gathering, consistent with embodiments of the present disclosure.

FIG. 8 shows a flow chart of an example of sub-steps corresponding to a step of the method of FIG. 7, consistent with embodiments of the present disclosure.

FIG. 9 shows an example of a scheduling page of a graphical user interface (GUI) for display on the user terminal of FIG. 2, consistent with embodiments of the present disclosure.

FIG. 9A shows an example of a technician guided experience start page of a GUI for display on the technician terminal of FIG. 4, consistent with embodiments of the present disclosure.

FIG. 10 shows an example of a video conference page of a GUI for display on the user terminal of FIG. 2, consistent with embodiments of the present disclosure.

FIG. 11 shows an example of a measurement page of a GUI for display on the user terminal of FIG. 2, consistent with embodiments of the present disclosure.

FIG. 11A shows an example of one or more guidance augmented reality elements configured to be overlayed on one or more images shown on the measurement page of FIG. 11, consistent with embodiments of the present disclosure.

FIG. 12 shows an example of a visualization page of a GUI for display on the user terminal of FIG. 2, consistent with embodiments of the present disclosure.

FIG. 13 shows an example of an agreement page of a GUI for display on the user terminal of FIG. 2, consistent with embodiments of the present disclosure.

### DETAILED DESCRIPTION

The present disclosure is generally related to an installation sizing system. The installation sizing system includes at least a technician terminal and a user terminal. The user terminal is configured to communicatively couple to the technician terminal (e.g., via a network such as the internet) to enable bidirectional communication between the user terminal and the technician terminal. The user terminal may include a camera, a distance sensor, and a user terminal display. The user terminal display is configured to display one or more images (e.g., in the form of a video feed) generated by the camera (e.g., in the form of video). The user terminal is further configured to generate one or more augmented reality elements that are overlayed on the one or more images.

In one example, the user terminal is moved around a space (e.g., a room) while capturing one or more images and associating distance data with one or more portions (e.g., one or more pixels or pixel groups) within the one or more images. When the user positions the user terminal such that the camera captures one or more images of an installation region within the room, the user may indicate within the one or more images a first point of interest and a second point of interest of the installation region, the first point of interest being spaced apart from the second point of interest by a separation distance. The separation distance corresponds to at least one dimension (e.g., length, width, or depth) of the installation region.

Using the depth data, the user terminal is configured to calculate the separation distance extending between the first and second points of interest to determine a dimension of the installation region. A piece of equipment capable of being installed at the installation region may be determined based, at least in part, on the determined dimension.

In some instances, the determined piece of equipment may be associated with an augmented reality element. The augmented reality element corresponding to the piece of equipment may be overlayed on the one or more images at the installation region such that the piece of equipment can be visualized within the installation region.

The process of obtaining the one or more dimensions and visualization of selected equipment may be carried out cooperatively by a technician operating the technician terminal and a user operating the user terminal. Such a configuration allows for remote collaboration between the two parties. This may make the process of selecting equipment to be installed at the installation region more efficient by, for example, reducing one or more of the cost and/or the time associated with selecting and visualizing equipment.

In one example, the installation sizing system can be leveraged in the context of equipment sales. For example, a sales agent may request a customer install an application on a smartphone that allows the sales agent to communicate with the customer in real time. During the communication, the sales agent can guide the customer on how and where to obtain dimensions corresponding to an installation region for a piece of equipment. After obtaining the dimensions, the sales agent and customer can review acceptable equipment and, using augmented reality elements, allow the customer to visualize the acceptable equipment within the environment. If the customer agrees to install a piece of equipment, the sales agent, using the application installed on the smartphone, may complete a purchase and sales agreement with the customer.

In another example, the installation sizing system may be used by designers (e.g., architects, engineers, interior designers, and/or the like) to determine one or more dimensions of an installation region (either independently or with the guidance of a remote party). Upon obtaining the one or more dimensions, the designer may review equipment (e.g., furniture, appliances, heating/cooling systems, plumbing systems, lighting systems, and/or the like) capable of being installed within the installation region and proceed to visualize the equipment within the installation region through augmented reality elements.

In yet another example, the installation sizing system may be used in the context of tours (e.g., college campus tours, real estate tours, and/or the like). In the example of a real estate tour, the installation sizing system may allow a potential buyer to visualize their furniture, paint choices, and/or the like within yet to be purchased real-estate.

In yet another example, the installation sizing system may be used in an academic context. In this example, students (e.g., engineering students) may be able to visualize life-sized augmented reality elements corresponding real-life equipment. In the case of engineering students, the engineering students may be able to visualize individual components designed by the students (e.g., in a classroom setting) within an actual device. In this case, the engineering students may be encouraged to learn techniques for reverse engineering one or more components (e.g., in the context of equipment repair) and/or for engineering components to fit in a larger system (e.g., a vehicle such as a car or an airplane).

In yet another example, the installation sizing system may be utilized by retailers to allow customers to virtually interact with one or more products sold by the retailer. In this example, the products sold by the retailer may be visualized within the customer's environment. As such, the customer may determine whether they have sufficient space for a product prior to purchasing the product. As may be appreciated this may reduce the number of product returns that the retailer experiences.

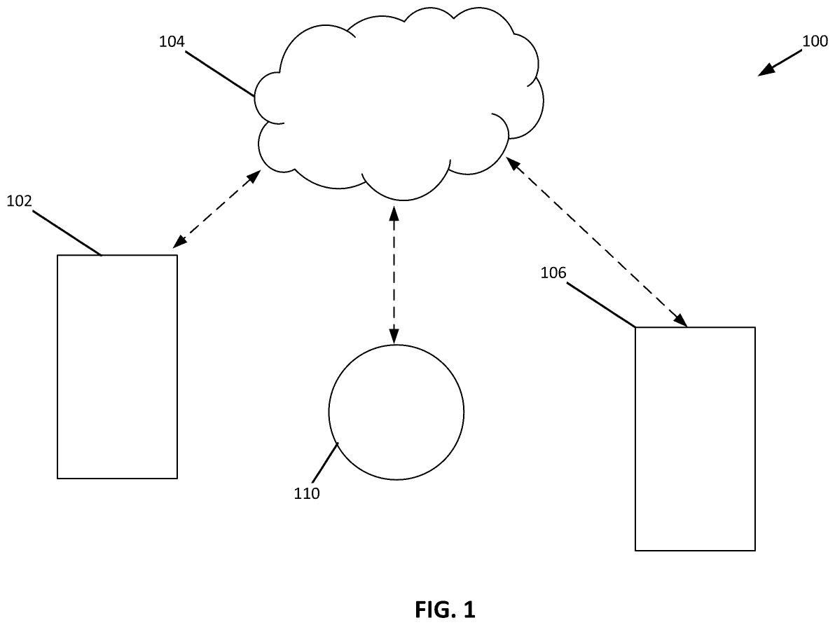

FIG. 1 shows a schematic block diagram of an installation sizing system 100. As shown, the installation sizing system 100 includes a technician terminal 102 communicatively coupled to a network 104 (e.g., the internet), and a user terminal 106 communicatively coupled to the network 104. The user terminal 106 is communicatively coupled to the technician terminal 102 (e.g., via the network 104), enabling bidirectional communication between the user terminal 106 and the technician terminal 102. In one example, the technician terminal 102 and the user terminal 106 may be configured to cooperate to determine one or more pieces of acceptable equipment for installation within an environment (e.g., a room). The user terminal 106 and the technician terminal 102 may be any one or more of a smartphone, a laptop computer, a desktop computer, a tablet, a user worn smart device (e.g., augmented reality goggles), and/or any other device.

In some instances, one or more of the user terminal 106 and/or the technician terminal 102 may be communicatively coupled (e.g., via the network 104) to a cloud computing server 110. The user terminal 106 and/or the technician terminal 102 may be configured to offload one or more processes (e.g., calculations) to the cloud computing server 110, which may allow for more resource intensive tasks to be performed without increasing a computing power of the user terminal 106 and/or the technician terminal 102. In some instances, the cloud computing server 110 (and/or the technician terminal 102) may include one or more databases (e.g., one or more equipment databases, one or more pricing databases, one or more inventory databases, and/or any other database) that are accessible to the user terminal 106 and/or the technician terminal 102.

The cloud computing server 110 may include one or more of a Linux, Apache HTTP Server, MySQL, PHP/Perl/Python (LAMP) stack, and/or a MongoDB, Express.js, AngularJS, Node.js (MEAN) stack to serve as application and/or database servers. However, the cloud computing server 110 may include any other suitable application and/or database server.

One or more of the technician terminal 102, the user terminal 106, and/or the cloud computing server 110 may include augmented reality elements that are configured to be overlayed on an image. The augmented reality elements may be configured to overlayed on an image generated using the user terminal 106 (e.g., to allow a user to visualize a piece of equipment within a space). The augmented reality elements may be generated using, for example, an Open Graphics Library (OpenGL) application programming interface (API), a Web Graphics Library (WebGL) A PI, and/or any other graphics library.

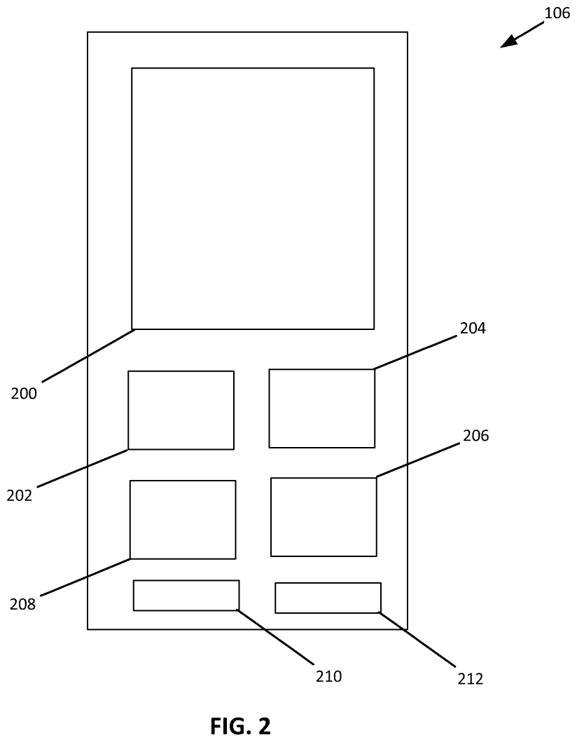

FIG. 2 shows a schematic example of the user terminal 106 of FIG. 1. As shown, the user terminal 106 includes a user terminal display 200 (e.g., a touch enabled display), one or more sensors 202, one or more user terminal communication modules 204, one or more user terminal processors 206, and one or more (non-transitory) user terminal memories 208 configured to store one or more instructions. The one or more user terminal processors 206 are communicatively coupled to the user terminal display 200, the one or more sensors 202, and/or the one or more user terminal memories 208. The one or more user terminal processors 206 are configured to execute one or more instructions stored in the one or more user terminal memories 208. For example, the one or more user terminal processors 206 may be communicatively coupled to the one or more sensors 202 and be configured to cause one or more behaviors to be carried out based, at least in part, on outputs from the one or more sensors 202 and instructions stored in the one or more user terminal memories 208. In one example, outputs from the one or more sensors 202 may be illustrated on the user terminal display 200 and/or be transmitted to an external device (e.g., the technician terminal 102 and/or the cloud computing server 110 of FIG. 1) via the one or more user terminal communication modules 204.

The user terminal display 200 may include any one or more of a liquid crystal display (LCD), an organic light emitting diode (OLED) display, a light emitting diode (LED), and/or any other device capable of visually displaying information. The user terminal display 200 may be configured as a touch enabled display that is configured to receive one or more touch inputs. For example, the user terminal display 200 may be configured to generate touch data that corresponds to the region of the display being touched. The touch data may be configured to be associated with additional data (e.g., image data, distance data, and/or any other type of data). Such a configuration may allow, for example, a three-dimensional point that is associated with a respective touch point to be generated using touch data and distance data. The one or more sensors 202 may include any one or more of a distance measuring sensor (e.g., an ultrasonic sensor, an infrared, IR, sensor, a time of flight sensor, a light detection and ranging, LIDAR, sensor, and/or any other kind of distance measuring sensor), one or more cameras, one or more orientation sensors (e.g., a gyroscope, a inertial measurement unit, and/or any other type of orientation sensor), one or more localization sensors (e.g., a global positioning system, GPS, sensor and/or any other localization sensor), and/or any other type of sensor. The one or more user terminal communication modules 204 can be configured to send and/or receive radio frequency (RF) signals (e.g., pursuant to one or more of a WiFi protocol, a Bluetooth protocol, a Zigbee protocol, a cellular communication protocol, and/or any other communication protocol). Additionally, or alternatively, the one or more user terminal communication modules 204 can be configured to send and/or receive line of sight communications (e.g., light based communication protocols such as IR communication protocols).

In some instances, and as further shown, the user terminal 106 may include one or more audio outputs 210. The one or more audio outputs 210 may be configured to generate an audible sound configured to convey information to a user of the user terminal 106. For example, the one or more audio outputs 210 may be configured to emit an audible sound that corresponds to the outputs of the one or more sensors 202. The one or more audio outputs 210 may include one or more of a speaker, a mechanical bell, a mechanical buzzer, and/or any other form of audio output 210. Additionally, or alternatively, the user terminal 106 may include an audio input device 212. The audio input device 212 can be configured to receive an audio input (e.g., speech) from a user of the user terminal 106. The audio input may be communicated to an external device (e.g., the technician terminal 102 of FIG. 1). The audio input device 212 may include, for example, a microphone.

In some instances, the user terminal 106 may be configured to utilize one or more remote computing systems to carry out one or more operations. For example, the user terminal 106 may be configured to communicatively couple with the cloud computing server 110 (e.g., via the network 104).

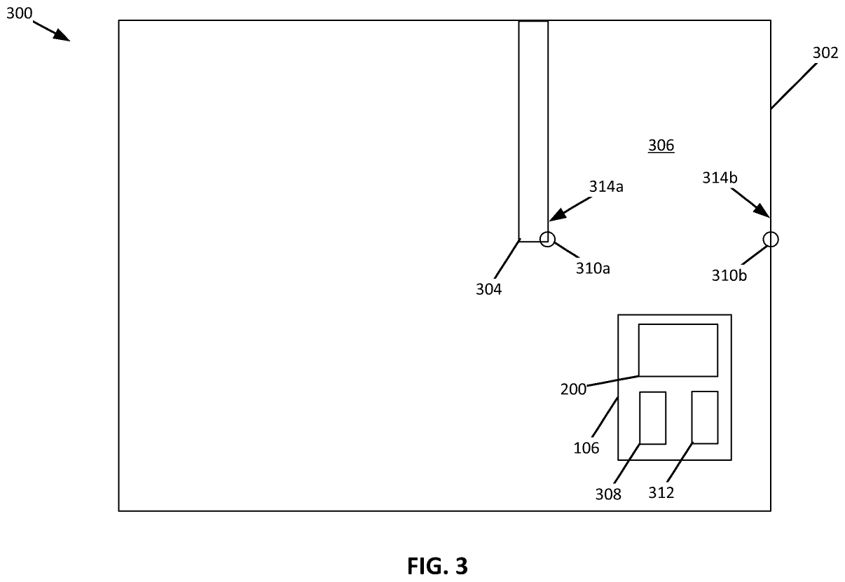

FIG. 3 shows a schematic example of the user terminal 106 disposed within a room (or space) 300. As shown, the room 300 includes one or more walls 302 and one or more room (or space) features 304 (e.g., a stairwell, a partial wall, a bar, an additional wall, a semi-permanent fixture such as a movable fixture requiring access to plumbing, and/or any other room feature). An installation region 306 extends between the one or more walls 302 and the one or more room features 304. The installation region 306 corresponds to a region where a piece of equipment is desired to be installed. While the installation region 306 is shown as being disposed between the one or more walls 302 and the one or more room features 304, other configurations are possible. For example, the installation region 306 may be disposed between a plurality of room features 304. While FIG. 3 is shown and described in the context of a room, other configurations are possible. For example, the user terminal 106 may be moved around an outdoor space having the installation region 306.

The user terminal 106 may be moved within the room 300 (e.g., through the movement of a user) to collect dimensional data within the room 300. While the user terminal 106 is moved throughout the room 300, one or more distance sensors 308 (which are examples of the one or more sensors 202 of FIG. 2) may generate distance data and one or more cameras 312 may capture one or more images (the one or more cameras 312 being an example of the one or more sensors 202 of FIG. 2). For example, the one or more cameras 312 may be configured to generate a video feed to be displayed on the user terminal display 200 (e.g., the video feed may be a substantially real-time representation of at least a portion of the room 300 that is within a field of view of the one or more cameras 312) and the one or more distance sensors 308 may be configured to generate distance data, wherein at least portion of the generated distance data may be associated with at least a portion of the video feed (e.g., with at least a portion of one or more images forming the video feed).

The user terminal 106 can be configured to associate the generated distance data with corresponding images (e.g., with at least a portion of a video feed, the video feed including a plurality of images). As such, a distance to one or more features within the room 300 may be associated with one or more portions (e.g., one or more pixels or one or more pixel groups) of the captured images. In this way, a user may indicate a plurality of points of interest 310a and 310b within the room 300 by interacting with the one or more images shown on the user terminal display 200. For example, the installation region 306 may include the points of interest 310a and 310b. The points of interest 310a and 310b correspond to endpoints of a desired dimension (e.g., length, width, and/or height) to be measured. In one example, a user of the user terminal 106 may touch locations within the one or more images shown on the user terminal display 200 that correspond to the points of interest 310a and 310b. In another example, the user may indicate the points of interest 310a and 310b by making hand gestures (e.g., pointing) that indicate the points of interest 310a and 310b within the field of view of the one or more cameras 312.

The user terminal 106 can be configured to determine a dimension corresponding to the installation region 306 based, at least in part, on the distance data. For example, using the distance data associated with the one or more images, a separation distance extending between the points of interest 310a and 310b may be determined. The separation distance between the points of interest 310a and 310b corresponds to at least one desired dimension. For example, the user terminal display 200 may be configured to receive at least a first touch input and a second touch input from the user of the user terminal 106 while a video feed showing the installation region 306 is being displayed on the user terminal display 200. The first touch input corresponds to the first point of interest 310a and the second touch input corresponds to the second point of interest 310b. As such, the first touch input can be associated with a first portion of the collected distance data (e.g., a three-dimensional coordinate corresponding to the location within the video feed touched) and the second touch input can be associated with a second portion of the collected distance data (e.g., a three-dimensional coordinate corresponding to the location within the video feed touched). In this way, the desired dimension may be determined based, at least in part, on the first and second portions of the collected distance data. After the desired dimension is determined, the desired dimension can be transmitted to an external device (e.g., the technician terminal 102 and/or the cloud computing server 110) such that, for example, the external device can cause an indication of one or more acceptable pieces of equipment for installation within the installation region 306 to be received at the user terminal 106.

In some instances, the calculation of the distance between the points of interest 310a and 310b may include correcting for human error introduced as a result of the user indicating the points of interest 310a and 310b using touch inputs received on the user terminal display 200. For example, the user terminal display 200 may be configured to use the one or more cameras 312 to capture one or more images (e.g., a video feed) to be rendered on the user terminal display 200 (e.g., substantially in real-time), wherein the one or more images include at least the installation region 306. While the one or more images (e.g., video feed) are being rendered on the user terminal display 200, the user may touch areas on the user terminal display 200 corresponding to outer bounds 314a and 314b (e.g., vertical and/or horizontal boundaries) of the installation region 306 to generate the points of interest 310a and 310b. In some instances, the user input to the user terminal display 200 may not have the precision necessary to accurately identify the outer bounds 314a and 314b of the installation region 306. In these instances, the touch inputs corresponding to the points of interest 310a and 310b may be automatically adjusted to correspond to the outer bounds 314a and 314b. For example, the user terminal 106 may be configured to carry out an edge detection analysis on at least one of the one or more images. In some instances, the edge detection analysis may include use of data generated by the one or more distance sensors 308 (e.g., to detect sudden changes in distance as being indicative of an edge). Additionally, or alternatively, the touch inputs identifying the points of interest 310a and 310b may not be within the same horizontal and/or vertical plane, which may result in the calculated distance being greater than the actual distance between the points of interest 310a and 310b. In these instances, the location of the touch inputs corresponding to the points of interest 310a and 310b may be automatically adjusted to be within the same vertical or horizontal plane. For example, a three-dimensional point associated with each touch point may be adjusted such that at least one of the X, Y, or Z coordinate is the same for each three-dimensional point. After adjustment of the touch points, the desired dimension may be determined based, at least in part, on the distance data associated with each adjusted touch point. In some instances, adjustment of the indicated points of interest may, generally be described, as adjusting the indicated points of interest such that a line connecting (or intersecting) each of the indicated points of interest is substantially level with a floor (e.g., for width and depth dimensions) or substantially plumb with a wall (e.g., for height dimensions). In these instances, the floor may generally be described as representing a horizontal plane (e.g., the horizontal plane being a plane that extends parallel to the floor) and a wall may generally be described as representing a vertical plane (e.g., the vertical plane being a plane that extends parallel to the wall). As such, the orientation of the horizontal plane and the orientation of the vertical plane may be determined relative to the orientation of the room 300 (e.g., which may account for imperfections resulting from construction) instead of the orientation being determined relative to gravity.

In some instances, the user terminal 106 may be configured to generate one or more augmented reality elements to be overlayed on images generated on the user terminal display 200. The one or more augmented reality elements may correspond to potential equipment capable of being positioned within the installation region 306. For example, after the dimensions of the installation region 306 are determined, equipment having a size capable of fitting within the installation region 306 may determined. After properly sized equipment is determined, the user terminal 106 may be configured to overlay an augmented reality element corresponding to the equipment on an image (e.g., a video feed) on the user terminal display 200 that includes at least the installation region 306. The augmented reality element can be configured to be fixed relative to the installation region 306 such that, as the user terminal 106 moves relative to the installation region 306, the location of augmented reality element remains fixed (i.e., does not move). Such a configuration may allow for better visualization of a fitment of the equipment within the installation region 306. In some instances, the position and/or orientation of the augmented reality element relative to the installation region 306 may be adjusted (e.g., to visualize alternative placements and/or orientations).

In some instances, the user terminal 106 may be configured to generate a map of the room 300. For example, the one or more distance sensors 308 can be configured to generate distance data as a user moves about the room 300. The generated distance data can be used to generate a floor plan corresponding the room 300 and/or corresponding to a portion of the room 300. The floor plan may be a three-dimensional floor plan that includes both horizontal and vertical dimensions. The floor plan can be provided to an external device (e.g., the technician terminal 102 of FIG. 1). For example, the floor plan can be used (e.g., by a technician) to generate proposed equipment locations. The proposed equipment locations may be transmitted to the user terminal 106. The user terminal 106 may then use the proposed equipment locations to overlay one or more augmented reality elements on one or more images that include the proposed equipment locations, allowing a user of the user terminal 106 to visualize the equipment within the room 300 (e.g., at multiple different locations).

Determination of the dimensions of the installation region 306 and/or the visualization of the equipment within the room (e.g., within the installation region 306) may be a self-guided experience or a technician-guided experience. When the experience is a self-guided experience, the user of the user terminal 106 may independently obtain the desired dimensions (e.g., in response to automated prompts generated on the user terminal display 200 of the user terminal 106). When the experience is a technician-guided experience, a technician may communicate instructions to the user via the user terminal 106. For example, the technician, using the technician terminal 102 may communicate via video, voice, and/or text with the user of the user terminal 106. In addition to providing guidance to the user, the technician may be able to initiate and complete a sales agreement with the user that authorizes the purchase and installation of acceptable equipment. In some instances, the experience may be a hybrid experience. In a hybrid experience, the user may independently obtain the desired dimensions (e.g., using automated prompts), schedule a time with a technician to review acceptable equipment, and, at the scheduled time the technician may review the acceptable equipment with the user (e.g., by using augmented reality elements to visualize the placement of the equipment). When reviewing the acceptable equipment, the technician and user may communicate through the technician and user terminals 102 and 106, respectively. In some instances, if a user approves of the acceptable equipment, the user may, prior to terminating communication with the technician, complete a sales agreement authorizing the purchase and installation of the acceptable equipment.

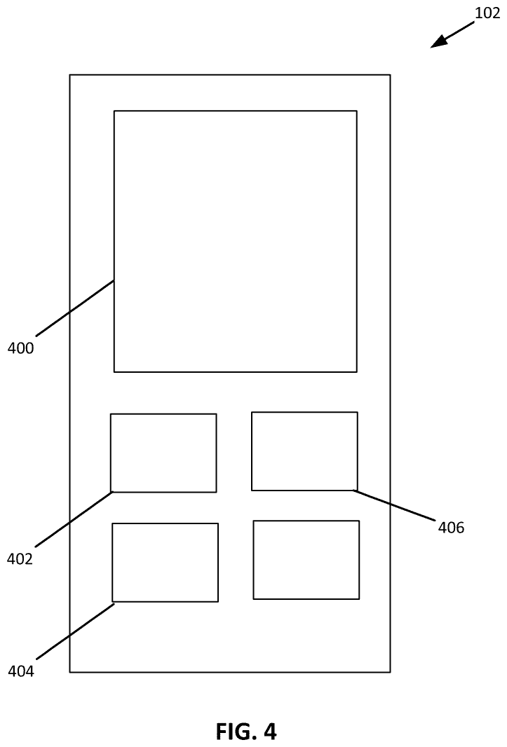

FIG. 4 shows a schematic example of the technician terminal 102. In some instances, the technician terminal 102 may have a configuration similar to the user terminal 106. As shown, the technician terminal 102 includes a technician terminal display 400, one or more technician terminal communication modules 402, one or more technician terminal processors 404, and one or more (non-transitory) technician terminal memories 406. The one or more technician terminal communication modules 402 can be configured to communicatively couple to the user terminal 106 (e.g., via the network 104 and/or directly). For example, technician terminal 102 may be configured to receive the one or more dimensions corresponding to the installation region 306 (FIG. 3) from the user terminal 106. The one or more dimensions may be used by the technician terminal 102 to identify equipment capable being installed in the installation region 306. Once the equipment is identified, the technician terminal 102 may cause augmented reality elements corresponding to the equipment to be provided to the user terminal 106 such that the equipment may be visualized within the room 300.

In some instances, the technician terminal 102 may be configured such that bidirectional communication between the technician and a user of the user terminal 106 can be carried out. For example, the technician terminal 102 and the user terminal 106 can be configured such that a video, voice, and/or text conversation is facilitated between the user and the technician. Such a configuration may allow for real time discussions regarding fitment, orientation, aesthetics, and/or the like of the equipment to take place. The technician terminal 102 may be configured to store details relating to the user of the user terminal 106 (e.g., contact information, conversational notes, and/or the like).

In some instances, the technician terminal 102 may be configured to utilize one or more remote computing systems to carry out one or more operations. For example, the technician terminal 102 may be configured to communicatively couple with the cloud computing server 110 (e.g., via the network 104).

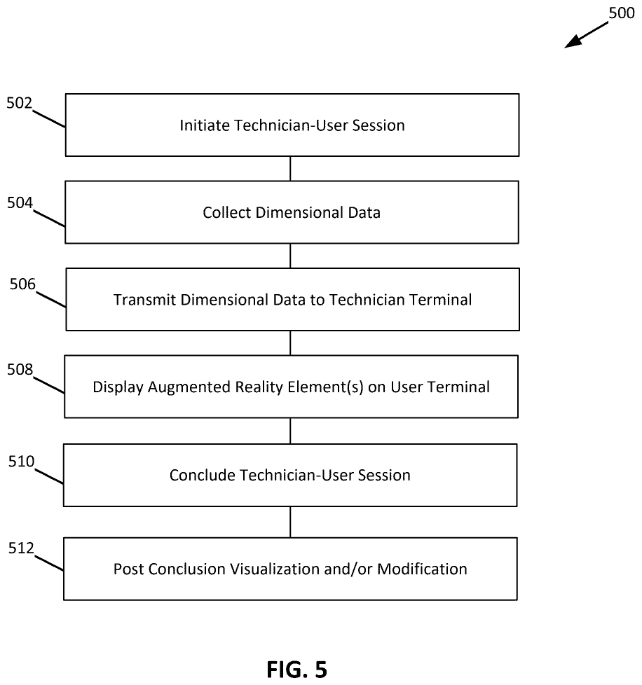

FIG. 5 shows a flow chart of a method 500 of technician guided dimension gathering. One or more steps of the method 500 may be carried out by one or more of the user terminal 106, the technician terminal 102, and/or the cloud computing server 110. For example, one or more steps of the method 500 may be embodied as one or more instructions stored in one or more of the one or more user terminal memories 208, the one or more technician terminal memories 406, and/or the cloud computing server 110, wherein the one or more instructions may be executed by one or more of the one or more user terminal processors 206, the one or more technician terminal processors 404, and/or the cloud computing server 110. Additionally, or alternatively, one or more steps of the method 500 may be carried out in any combination of software, firmware, and/or circuitry (e.g., an application-specific integrated circuit).

In one example, the method 500 may be at least partially embodied as an application that runs on the user terminal 106. In this example, the application may cause the user terminal 106 to generate a graphical user interface (GUI) that is rendered on the user terminal display 200. The GUI may be configured to provide visual guidance to the user (e.g., in the form of prompts, video feeds, augmented reality elements, and/or the like). When the user terminal 106 is a smartphone or tablet computer, the application may be developed with cross-platform frameworks such as React Native integrated with a mobile augmented reality (AR) software development kit (SDK) such as A R Core, ARK IT, or Vuforia. Similarly, the method 500 may be at least partially embodied as an application that runs on the technician terminal 102. In these instances, the application may cause the technician terminal 102 to generate a GUI that is rendered on the technician terminal display 400. The GUI may be configured to provide visual guidance to the technician (e.g., in the form of scheduling options, quote generation, video feeds, prompts, and/or the like). When the technician terminal 102 is a smartphone or tablet computer, the application may be developed with cross-platform frameworks such as React Native integrated with a mobile augmented reality (AR) software development kit (SDK) such as ARCore, ARKIT, or Vuforia.

As shown, the method 500 may include a step 502. The step 502 includes initiating a technician-user session. Initiating the technician-user session may include authenticating the technician and the user on a respective one of the technician terminal 102 and the user terminal 106. Authentication may include requesting (e.g., via a graphical user interface on the user terminal display 200 and/or on the technician terminal display 400) login credentials (e.g., a username and password, biometric markers, such as fingerprint identification, and/or any other form of credentials). In response to the technician and user being authenticated, the technician and user may be prompted to join the technician-user session. Once the technician-user session is established, the technician terminal 102 and the user terminal 106 are communicatively coupled (e.g., via the network 104) such that the user and the technician may bidirectionally communicate (e.g., via voice, text, and/or video). For example, the user terminal and the technician terminal may be configured for bidirectional audio-video communication for at least a portion of the technician-user session.

The method 500 may include a step 504. The step 504 includes collecting dimensional data of the installation region 306 and/or of the room 300. During the step 504 the technician may provide guidance to the user via the bidirectional communication established in the step 502. For example, the technician may indicate to the user where the points of interest (e.g., the points of interest 310a and 310b) between which a measurement is to be taken are located. In this example, the technician may provide verbal and/or visual guidance to the user. The visual guidance may include generation of temporary augmented reality elements that are overlayed on one or more images generated by the one or more cameras 312, wherein the temporary augmented reality elements identify each of the points of interest within the one or more images displayed on the user terminal display 200. The user of the user terminal 106 may then touch the user terminal display 200 at the location of the temporary augmented reality elements to establish the points of interest. Requiring the user to physically interact with the user terminal display 200 to generate the points of interest, instead of allowing the technician to directly identify the points of interest, may reduce the number of security permissions required to be granted to the technician terminal 102 by the user terminal 106 (e.g., the technician terminal 102 may not have access to one or more of the sensors 202 of the user terminal 106).

The method 500 may include a step 506. The step 506 includes transmitting the collected dimensional data to the technician terminal 102 and/or the cloud computing server 110. In some instances, the technician terminal 102 and/or the cloud computing server 110 may be configured to compare the dimensional data with known dimensions of one or more pieces of equipment. For example, the technician terminal 102 and/or the cloud computing server 110 may include a database of equipment types (e.g., mobility assistance equipment such as an elevator or chair lift, an appliance such as a dishwasher or refrigerator, consumer electronics such as a television or audio-visual equipment rack, networking equipment, and/or any other equipment type). In some instances, the technician may select one equipment type from a group of equipment types and the technician terminal 102 and/or the cloud computing sever 110 may be configured to determine one or more pieces of acceptable equipment for installation in the installation region 306 from equipment associated with the selected equipment type. Acceptable equipment includes equipment having dimensions that are less than or equal to the dimensions of the installation region 306.

The method 500 may include a step 508. The step 508 includes displaying one or more augmented reality elements corresponding to at least one of the pieces of acceptable equipment on the user terminal display 200. The augmented reality elements have an appearance that is similar to that of the corresponding equipment. The one or more augmented reality elements may be transmitted from the technician terminal 102 and/or the cloud computing server 110 to the user terminal 106 (e.g., via the network 104). The one or more augmented reality elements may be overlayed on one or more images (e.g., a video feed) generated by the one or more cameras 312. For example, the one or more cameras 312 may be configured to capture a series of images in the form of a video feed and the video feed may be caused to be displayed on the user terminal display 200. The one or more augmented reality elements may be caused to be overlayed on the video feed such that, as the user moves within the room 300, the one or more augmented reality elements remain fixed. In this way, the user may be able to visualize the acceptable equipment within the room 300 from multiple perspectives. Such a configuration may allow a user to readily spot issues with fitment and/or orientation. In some instances, the orientation and/or placement of the one or more augmented reality elements may be adjusted by the user and/or the technician. For example, the user may desire to see the augmented reality element in a different location from the installation region 306 and/or in a different orientation within the installation region 306. In this example, if the augmented reality element conflicts with an existing portion of the room 300 (e.g., a wall, a piece of furniture, an overhead obstacle, and/or the like), the conflict can be illustrated (e.g., by highlighting areas where conflicts are detected with a different color or generating a strobing animation).

The method 500 may include a step 510. The step 510 includes concluding the technician-user session. Concluding the user technician-session may include identifying at least one of the pieces of acceptable equipment as equipment to be installed. When the equipment to be installed is identified, the technician terminal 102 may generate and provide a quote (e.g., cost, timeline, and/or the like) for installing the equipment to be installed and transmit the quote to the user terminal 106. The user, after reviewing the quote on the user terminal 106, may authorize or decline the quote. If the quote is authorized, the user may be presented with potential installation dates on the user terminal 106, wherein the user is able to select one or more dates for installation. The selected installation dates and the signed (e.g., digitally) quote can be returned to the technician terminal 102.

The method 500 may include a step 512. The step 512 includes post conclusion visualization and/or modification. During post conclusion visualization and/or modification, the user terminal 106 (and/or the technician terminal 102) may access a recording of the technician-user session and/or the augmented reality elements from the technician-user session. In other words, the technician-user session may be recorded for post session viewing. For example, the user may use the user terminal 106 to visualize the equipment to be installed at the installation region 306 and make one or more modifications to its position and/or orientation. In some instances, the modifications may include replacing the equipment to be installed with alternative acceptable equipment. These modifications may then be provided to the technician terminal for review and/or approval. In some instances, the modifications may necessitate an adjustment to the scheduled installation date, installation timeline, and/or cost. In these instances, a revised quote may be transmitted from the technician terminal 102 to the user terminal 106 for approval by the user.

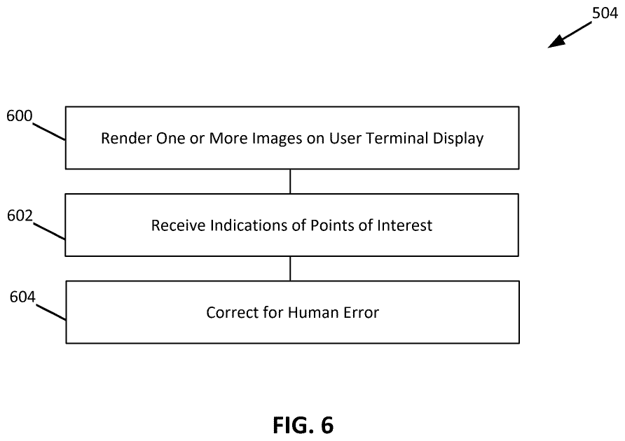

FIG. 6 shows a flow chart showing an example of one or more sub-steps of the step 504 of FIG. 5, which corresponds to the collection of dimensional data.

The step 504 may include the sub-step 600. The sub-step 600 includes causing one or more images captured by the one or more cameras 312 to be rendered on the user terminal display 200. The one or more images may be rendered in the form of a video feed. The video feed may be a substantially real-time representation of at least a portion of the room 300. The user (e.g., in response to prompts from the technician) may position the user terminal 106 such that the one or more cameras 312 capture the installation region 306.

The step 504 may include the sub-step 602. The sub-step 602 includes receiving indications of the points of interest within the one or more images from a user of the user terminal 106, while one or more images of the installation region 306 are rendered on the user terminal display 200. One or more portions of the image (e.g., one or more pixels or pixel groups) may be associated with distance data (e.g., in the form of three-dimensional points) generated by the one or more distance sensors 308 such that when the user indicates portions of the image that correspond to the points of interest (e.g., points of interest 310a and 310b), a separation distance extending between the points of interest can be calculated.

The step 504 may include the sub-step 604. The sub-step 604 may include correcting for human error introduced as a result of the user indicating points of interest within the room 300 using the one or more images. For example, the user may lack sufficient precision to accurately indicate one or more points of interest through touch input on the user terminal display 200. In other words, at least one indicated point of interest may be offset relative to a corresponding actual point of interest (e.g., 310a and/or 310b).

Correction for human error may include determining whether at least two indicated points of interest lie within a common horizontal and/or vertical plane. In other words, correction for human error may, in some instances, generally be described as determining whether a line connecting (or intersecting) each of the at least two indicated points is substantially level with a floor (e.g., for width and depth dimensions) or substantially plumb with a wall (e.g., for height dimensions). This determination may be made based, at least in part, on the distance data generated the one or more distance sensors 308. For example, the one or more distance sensors 308 may be configured to generate distance data in the form of a three-dimensional point, wherein the three-dimensional points for each indicated point of interest may be compared to determine if the indicated points of interest lie within a common horizontal and/or vertical plane.

For example, when a width or depth is desired to be measured, positioning the indicated points of interest within at least a common horizontal plane may be beneficial and, when a height is desired to be measured, positioning the indicated points of interest within at least a common vertical plane may be beneficial. In this example, when two or more dimensions are desired, at least three points of interest may be identified, wherein at least two points of interest lie in at least a common horizontal plane and at least two points of interest lie at least in a common vertical plane. In other words, one point of interest may serve as an origin point and a separation distance between each additional point of interest and the origin point may correspond to the desired dimensions. As may be appreciated, when measuring height, depth, and/or width, if the two indicated points of interest are offset (e.g., vertically and/or horizontally) a length of a line segment extending between the two indicated points of interest is greater than the dimension sought to be measured between the actual points of interest (e.g., 310a and 310b). Positioning of the two indicated points of interest within a common horizontal and/or vertical plane results in a length of a line segment extending between the two indicated points of interest corresponding to the dimension sought to be measured. In other words, the indicated points of interest may generally be described as being adjusted to match the location of the corresponding actual points of interest (e.g., 310a or 310b).

Additionally, or alternatively, correction of human error may include detecting one or more edges within the one or more images. The one or more edges may be indicative of one or more outer bounds of the installation region 306. When the one or more edges correspond to the outer bounds, the indicated points of interest may be adjusted to lie on the one or more edges. Detection of the one or more edges may include using image recognition and/or the distance data.

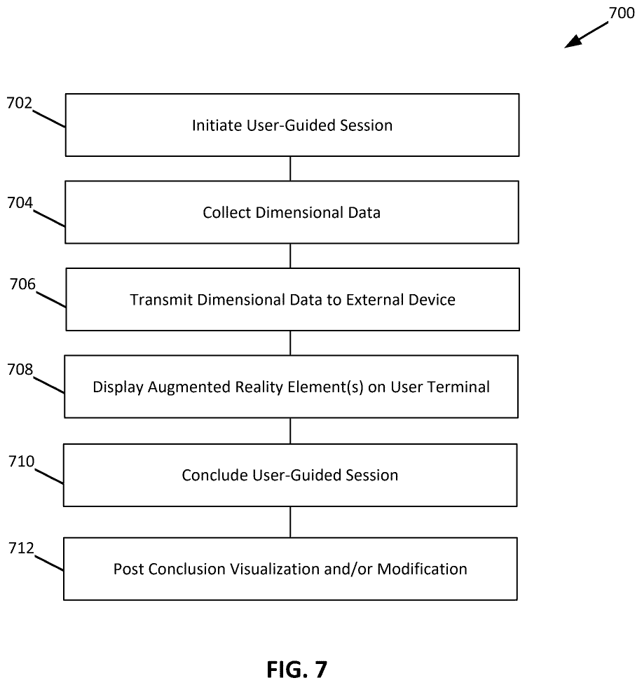

FIG. 7 shows a flow chart of a method 700 of self-guided dimension gathering. One or more steps of the method 700 may be carried out by one or more of the user terminal 106, the technician terminal 102, and/or the cloud computing server 110. For example, one or more steps of the method 500 may be embodied as one or more instructions stored in one or more of the one or more user terminal memories 208, the one or more technician terminal memories 406, and/or the cloud computing server 110, wherein the one or more instructions may be executed by one or more of the one or more user terminal processors 206, the one or more technician terminal processors 404, and/or the cloud computing server 110. Additionally, or alternatively, one or more steps of the method 700 may be carried out in any combination of software, firmware, and/or circuitry (e.g., an application-specific integrated circuit).

In one example, the method 700 may be at least partially embodied as an application that runs on the user terminal 106. In this example, the application may cause the user terminal 106 to generate a graphical user interface (GUI) that is rendered on the user terminal display 200. The GUI may be configured to provide visual guidance to the user (e.g., in the form of prompts, video feeds, augmented reality elements, and/or the like). When the user terminal 106 is a smartphone or tablet computer, the application may be developed with cross-platform frameworks such as React Native integrated with a mobile augmented reality (AR) software development kit (SDK) such as A R Core, ARK IT, or Vuforia. Similarly, the method 700 may be at least partially embodied as an application that runs on the technician terminal 102. In these instances, the application may cause the technician terminal 102 to generate a GUI that is rendered on the technician terminal display 400. The GUI may be configured to provide visual guidance to the technician (e.g., in the form of scheduling options, quote generation, video feeds, prompts, and/or the like). When the technician terminal 102 is a smartphone or tablet computer, the application may be developed with cross-platform frameworks such as React Native integrated with a mobile augmented reality (AR) software development kit (SDK) such as ARCore, ARKIT, or Vuforia.

As shown, the method 700 may include a step 702. The step 702 includes initiating a user guided session. The user guided session may include authenticating the user on the user terminal 106. Authentication may include requesting (e.g., via a graphical user interface on the user terminal display 200) login credentials (e.g., a username and password, biometric markers, such as fingerprint identification, and/or any other form of credentials). By authenticating the user, any data gathered during the user guided session may be associated with the user.

The method 700 may include a step 704. The step 704 includes collecting dimensional data of the installation region 306 and/or the room 300. During the step 704 the user may be presented with prompts (e.g., audible and/or visual prompts) using the user terminal 106. The prompts may provide the user with guidance as to how to identify one or more points of interest (e.g., points of interest 310a and 310b) within the installation region 306 and/or the room 300.

The method 700 may include a step 706. The step 706 includes transmitting the collected dimensional data to an external device such as, for example, the technician terminal 102 and/or the cloud computing server 110. The technician terminal 102 and/or the cloud computing server 110 may automatically (or with the guidance of a technician) determine one or more pieces of acceptable equipment. Acceptable equipment includes equipment having dimensions that are less than or equal to the dimensions of the installation region 306. In some instances, the collected dimensional data may be associated with an equipment type. As such, when the technician terminal 102 and/or the cloud computing server 110 includes a plurality of different equipment types, the technician terminal 102 and/or the cloud computing server 110 may automatically (or with the guidance of a technician) select one or more pieces of acceptable equipment that are associated with the selected equipment type and have dimensions that are less than or equal to the corresponding dimensions of the installation region 306.

The method 700 may include a step 708. The step 708 includes displaying one or more augmented reality elements corresponding to at least one of the pieces of acceptable equipment on the user terminal display 200. The augmented reality elements are configured to have an appearance that is similar to that of the corresponding acceptable equipment. The one or more augmented reality elements may be transmitted from the technician terminal 102 and/or the cloud computing server 110 to the user terminal 106 (e.g., via the network 104). The one or more augmented reality elements may be overlayed on one or more images (e.g., a video feed) generated by the one or more cameras 312. For example, the one or more cameras 312 may be configured to capture a series of images in the form of a video feed and the video feed may be caused to be displayed on the user terminal display 200. The one or more augmented reality elements may be caused to be overlayed on the video feed such that, as the user moves within the room 300, the one or more augmented reality elements remain fixed. In this way, the user may be able to visualize the acceptable equipment within the room 300 from multiple perspectives. Such a configuration may allow a user to readily spot issues with fitment and/or orientation. In some instances, the orientation and/or placement of the one or more augmented reality elements may be adjusted by the user. For example, the user may desire to see the augmented reality element in a different location from the installation region 306 and/or in a different orientation within the installation region 306. In this example, if the augmented reality element conflicts with an existing portion of the room 300 (e.g., a wall, a piece of furniture, an overhead obstacle, and/or the like), the conflict can be illustrated (e.g., by highlighting areas where conflicts are detected with a different color or generating a strobing animation).

The method 700 may include a step 710. The step 710 includes concluding the user-guided session. Concluding the user guided session may include identifying at least one of the pieces of acceptable equipment as equipment to be installed. The identified equipment may be transmitted to the technician terminal 102. The technician terminal 102 may automatically (or with the guidance of a technician) generate a quote (e.g., cost, timeline, and/or the like) for installing the equipment to be installed and transmit the quote to the user terminal 106. The user, after reviewing the quote on the user terminal 106, may authorize or decline the quote. If the quote is authorized, the user may be presented with potential installation dates on the user terminal 106, wherein the user is able to select one or more dates for installation. The selected installation dates and the signed (e.g., digitally) quote can be returned to the technician terminal 102.

The method 700 may include a step 712. The step 712 includes post conclusion visualization and/or modification. During post conclusion visualization and/or modification, the user terminal 106 (and/or the technician terminal 102) may access a recording of the user-guided session and/or the augmented reality elements from the user-guided session. For example, the user may use the user terminal 106 to visualize the equipment to be installed at the installation region 306 and make one or more modifications to its position and/or orientation. In some instances, the modifications may include replacing the equipment to be installed with alternative acceptable equipment. These modifications may then be provided to the technician terminal for review and/or approval. In some instances, the modifications may necessitate an adjustment to the scheduled installation date, installation timeline, and/or cost. In these instances, a revised quote may be transmitted from the technician terminal 102 to the user terminal 106 for approval by the user.

In any one of the steps 702-712 the user of the user terminal 106 may request assistance from a technician. In these instances, the user terminal 106 and the technician terminal 102 may be configured to establish bidirectional text, audio, and/or video communication between the user and the technician. In this way, a hybrid self-guided/technician-guided dimension gathering session may be established.

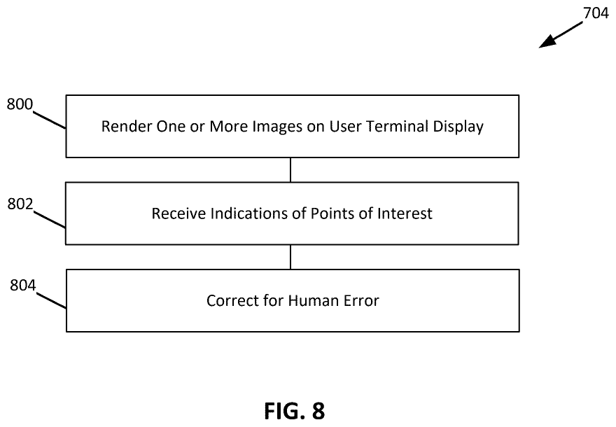

FIG. 8 shows a flow chart showing an example of one or more sub-steps of the step 704 of FIG. 7, which corresponds to the collection of dimensional data.

The step 704 may include the sub-step 800. The sub-step 800 includes causing one or more images captured by the one or more cameras 312 to be rendered on the user terminal display 200. The one or more images may be rendered in the form of a video feed. The video feed may be a substantially real-time representation of at least a portion of the room 300. The user may position the user terminal 106 such that the one or more cameras 312 capture the installation region 306.

The step 704 may include the sub-step 802. The sub-step 802 includes receiving indications of the points of interest within the one or more images from a user of the user terminal 106, while one or more images of the installation region 306 are rendered on the user terminal display 200. One or more portions of the image (e.g., one or more pixels or pixel groups) may be associated with distance data (e.g., in the form of three-dimensional points) generated by the one or more distance sensors 308 such that when the user indicates portions of the image that corresponds to the points of interest (e.g., points of interest 310a and 310b), a separation distance extending between the points of interest can be calculated.

The step 704 may include the sub-step 804. The sub-step 804 may include correcting for human error introduced as a result of the user indicating points of interest within the room 300 using the one or more images. For example, the user may lack sufficient precision to accurately indicate one or more points of interest through touch input on the user terminal display 200. In other words, at least one indicated point of interest may be offset from a corresponding actual point of interest (e.g., 310a and/or 310b).

Correction for human error may include determining whether at least two indicated points of interest lie within a common horizontal and/or vertical plane. In other words, correction for human error may, in some instances, generally be described as determining whether a line connecting (or intersecting) each of the at least two indicated points is substantially level with a floor (e.g., for width and depth dimensions) or substantially plumb with a wall (e.g., for height dimensions). This determination may be made based, at least in part, on the distance data generated the one or more distance sensors 308. For example, the one or more distance sensors 308 may be configured to generate distance data in the form of a three-dimensional point, wherein the three-dimensional points for each indicated point of interest may be compared to determine if the indicated points of interest lie within a common horizontal and/or vertical plane.

For example, when a width or depth is desired to be measured, positioning the indicated points of interest within at least a common horizontal plane may be beneficial and, when a height is desired to be measured, positioning the indicated points of interest within at least a common vertical plane may be beneficial. In this example, when two or more dimensions are desired, at least three points of interest may be identified, wherein at least two points of interest lie in at least a common horizontal plane and at least two points of interest lie at least in a common vertical plane. In other words, one point of interest may serve as an origin point and a separation distance between each additional point of interest and the origin point may correspond to the desired dimensions. As may be appreciated, when measuring height, depth, and/or width, if the two indicated points of interest are offset (e.g., vertically and/or horizontally) a length of a line segment extending between the two indicated points of interest is greater than the dimension sought to be measured. Positioning of the two indicated points of interest within a common horizontal and/or vertical plane results in a length of a line segment extending between the two points of interest corresponding to the dimension sought to be measured. In other words, the indicated points of interest may generally be described as being adjusted to match a position of a corresponding actual point of interest (e.g., 310a or 310b).

Additionally, or alternatively, correction of human error may include detecting one or more edges within the one or more images. The one or more edges may be indicative of one or more outer bounds of the installation region 306. When the one or more edges correspond to the outer bounds, the indicated points of interest may be adjusted to lie on the one or more edges. Detection of the one or more edges may include using image recognition and/or the distance data.

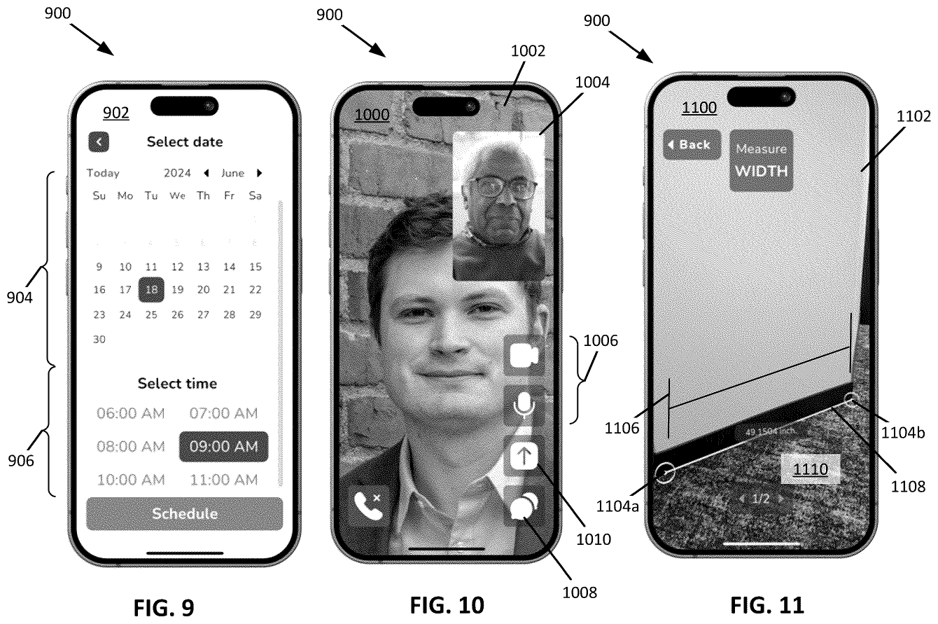

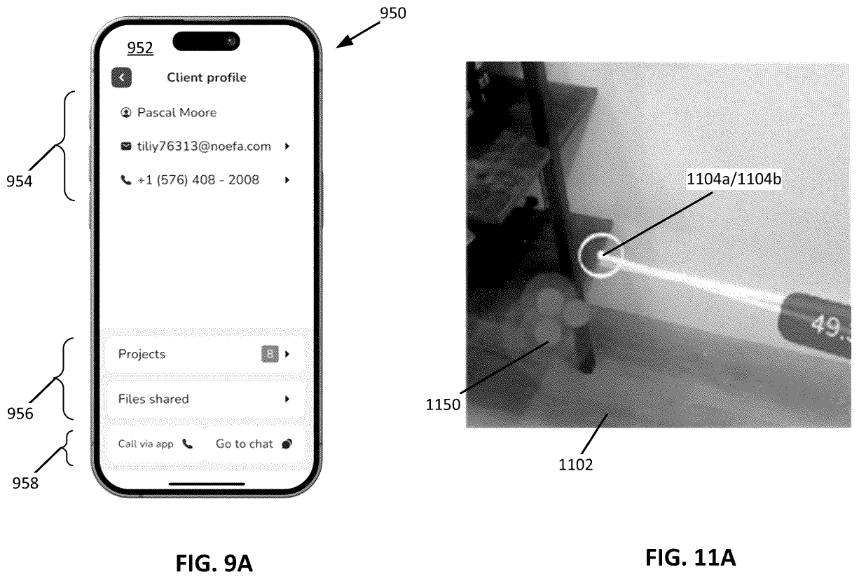

FIGS. 9 and 10-13 show an example user GUI 900 for generation on the user terminal 106. The illustrated user GUI 900 corresponds to a technician guided experience.

As shown in FIG. 9, after the user of the user terminal 106 is authenticated, the user may schedule a consultation with the technician. The user GUI 900 may provide a scheduling page 902 that includes one or more of a calendar element 904 and/or a time element 906. In some instances, the calendar element 904 and the time element 906 may only display dates and times that the technician is available. When the user selects a date and/or time for a consultation, the technician may be notified such that the technician may start the technician guided experience at the appropriate time.

FIG. 9A shows an example of a technician GUI 950 for generation on the technician terminal 102, wherein a technician guided experience start page 952 is shown. As shown, the technician guided experience start page 952 may include contact information 954 corresponding to a user of the user terminal 106, access elements 956 for accessing user data (e.g., user provided files, prior projects undertaken with a given user, and/or the like), and communication elements 958 (e.g., video, audio, and/or text communication elements) for starting the technician guided experience. The technician GUI 950 may be configured to include one or more additional pages that provide scheduling features (e.g., one or more calendars, one or more appointment lists, and/or the like), customer relationship management (CRM) features, and/or the like.

As shown in FIG. 10, the user GUI 900 may include a video conference page 1000. The video conference page 1000 is configured to facilitate a bidirectional audio-video conference between the technician and the user. The video conference page 1000 may include a technician view window 1002, a user view window 1004, one or more conferencing elements 1006 (e.g., end conference element, disable camera/microphone element, and/or the like), a text chat element 1008 for communicating via text, and/or a file upload element 1010 for uploading one or more files. In some instances, the video conference page 1000 may become available when the technician starts the technician guided experience. As may be appreciated, the video conferencing page may allow the technician and user to discuss goals, objectives, and expectations.

The conference between the technician and the user may use, for example, one or more communication protocols such as Web Real-Time Communication (WebRTC), Voice over Internet Protocol (VoIP), Session Initiation Protocol (SIP), and/or Real-Time Transport Protocol (RTP).

As shown in FIG. 11, the user GUI 900 may be configured to transition to a measurement page 1100 (e.g., from the video conference page 1000). For example, the technician may cause the transition to the measurement page 1100 and/or one of the conferencing elements 1006 may be configured to cause the transition to the measurement page 1100. While in the measurement page 1100, the video conference may transition to a unidirectional video conference and a bidirectional audio conference. For example, the technician may be able to view a video feed generated by the user terminal 106 while a bidirectional audio feed is maintained between the user terminal 106 and the technician terminal 102. Such a configuration may allow the technician to view the user's space and provide guidance (e.g., in substantially real-time) to the user based, at least in part, on the video feed. In some instances, the measurement page 1100 may include a tutorial mode to familiarize the user with the measurement page 1100 and the measurement process.

As shown, the measurement page 1100 is configured to show one or more images 1102 (e.g., in the form of a video feed) that corresponds to the user's space. As shown, the user may indicate on the image 1102 a first and a second point of interest 1104a and 1104b that are spaced apart by a separation distance 1106. Using the one or more sensors 202 of the user terminal 106, the separation distance 1106 may be determined. In the example shown, the separation distance 1106 corresponds to a width dimension. In some instances, the position of the indicated points of interest 1104a and 1104b may be automatically adjusted such that a line segment 1108 extending between the indicated points of interest 1104a and 1104b extends substantially parallel to a floor 1110. Substantially parallel may include, for example, being within 10° of, 5° of, 4° of, 3° of, 2° of, or 1° of parallel and/or as close to parallel as possible given the accuracy of the one or more sensors 202 used when adjusting the indicated points of interest 1104a and/or 1104b. The floor 1110 may, in some instances, generally be described as an example of a horizontal plane despite the floor 1110 not being horizontal relative a gravitational frame of reference. As such, the horizontal plane (and/or a vertical plane) may be established relative to the user's space. As such, the indicated points of interest 1104a and 1104b may, in some instances, generally be described as being adjusted such that the line segment 1108 is level with the floor 1110. One or more of the line segment 1108 and/or the indicated points of interest 1104a and 1104b may be shown as augmented reality elements that are overlayed on the one or more images 1102. Such a configuration may allow the user and/or the technician to verify that the appropriate dimension has been measured. In some instances, and as shown in FIG. 11A, the technician may cause one or more guidance augmented reality elements 1150 to be overlayed on the one or more images 1102 to guide the user in identifying the locations of points of interest shown within the image 1102.

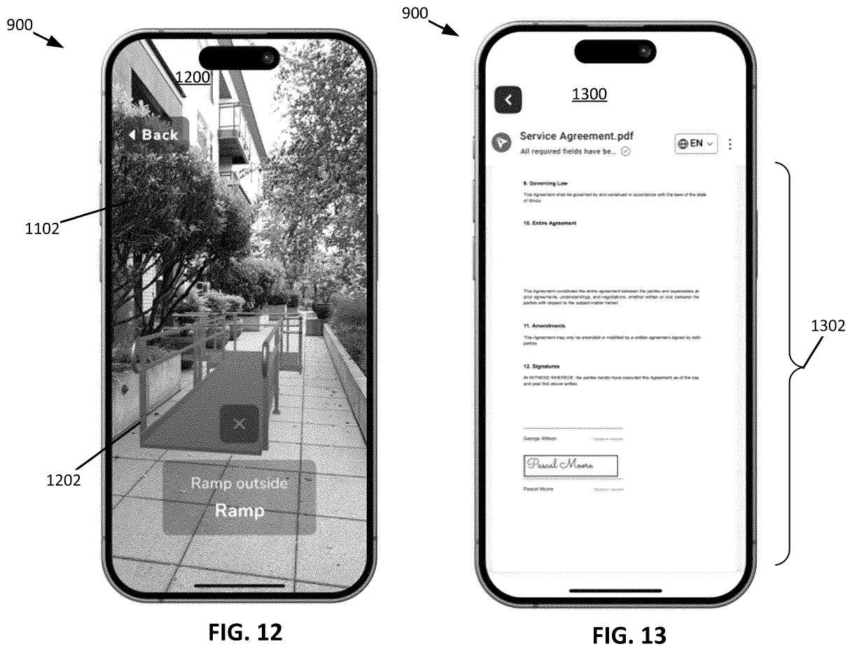

As shown in FIG. 12, the user GUI 900 may be configured to transition to a visualization page 1200 (e.g., from the video conference page 1000 and/or the measurement page 1100). For example, after the one or more dimensions are collected, the user and the technician may discuss acceptable equipment (e.g., equipment having dimensions that are less than or equal to the collected dimensions). The acceptable equipment may have corresponding augmented reality elements capable of being overlayed on the one or more images 1102. For example, and as shown, an equipment augmented reality element 1202 may be overlayed on the one or more images 1102 to allow the user to visualize the equipment within the space. The equipment augmented reality element 1202 can be configured to visually resemble the actual equipment. As shown, the equipment augmented reality element 1202 is shown as visually resembling a ramp for installation on exterior of a building.

Similar to the measurement page 1100, when at the visualization page 1200, a unidirectional video conference may be facilitated and a bidirectional audio conference may be facilitated. In this way, the technician may visualize the equipment within the space concurrently with the user while maintaining audio communication between the user and the technician. In some instances, the user and/or technician may make adjustments to a position and/or orientation of the equipment augmented reality element 1202 in order to visualize different placements and/or orientations. In some instances, the equipment augmented reality element 1202 may be configured to illustrate conflicts with real world elements within the one or more images 1102 (e.g., by changing colors, strobing, and/or the like).

In some instances, the user and/or the technician may associate one or more annotations (e.g., text, audio, and/or video annotations) with the equipment augmented reality element 1202. For example, when multiple different equipment augmented reality elements 1202 are displayed an annotation may be associated with a specific equipment augmented reality element 1202 (e.g., to indicate a user's opinions with regards to the equipment corresponding to the augmented reality element 1202). Additionally, or alternatively, annotations may be associated with a specific orientation and/or position of the equipment augmented reality element 1202 (e.g., to indicate a user's opinions with regards to the position or orientation of the equipment).

As shown in FIG. 13, the user GUI 900 may be configured to transition to an agreement page 1300 (e.g., from the video conference page 1000, the measurement page 1100, and/or visualization page 1200). For example, after visualizing each piece of acceptable equipment within the space, a user may select one or more of the acceptable pieces of equipment for purchase and/or installation. The agreement page 1300 may be configured to display a quote 1302 that the user is able to digitally sign and agree to. In some instances, the agreement page 1300 may further include and/or transition to a payment page to all the user to pay allow or a portion of any costs associated with purchasing a selected piece(s) of equipment. Additionally, or alternatively, the agreement page 1300 may further include and/or transition to a scheduling page to allow the user to schedule an installation date(s).

An example of an installation sizing system, consistent with the present disclosure, may include a user terminal and a technician terminal communicatively coupled with the user terminal, the technician terminal and the user terminal being configured to cooperate to determine one or more pieces of acceptable equipment for installation within an installation region. The user terminal may include one or more cameras configured to generate a video feed, a user terminal display configured to display the video feed, and one or more distance sensors configured to generate distance data associated with the video feed. The user terminal may be configured to determine a dimension corresponding to the installation region based at least in part on the distance data, transmit the dimension to the technician terminal, receive an indication of the one or more pieces of acceptable equipment, and overlay an augmented reality element on the video feed corresponding to at least one piece of the one or more pieces of acceptable equipment.

In some instances, the user terminal display may be configured to receive a first touch input and a second touch input while the video feed is being displayed and showing the installation region, the installation region including a first point of interest and a second point of interest, the first and second points of interest corresponding to a respective endpoint of the dimension. In some instances, the first touch input may be associated with a first portion of the distance data and the second touch input is associated with a second portion of the distance data. In some instances, the dimension may be determined based, at least in part, on the first and second portions of the distance data. In some instances, at least one of the first touch input or the second touch input may be adjusted such that both of the first and second touch inputs are within the same horizontal or vertical plane. In some instances, the dimension may be determined after at least one of the first touch input or the second touch input is adjusted. In some instances, the dimension may be determined during a technician-user session in which the user terminal and the technician terminal are configured for bidirectional audio-video communication for at least a portion of the technician-user session. In some instances, during the technician-user session, the augmented reality element may be overlayed on the video feed when the video feed includes the installation region. In some instances, during the technician-user session, an installation date may be scheduled. In some instances, the technician-user session may be recorded for post session viewing.

An example of a user terminal for use with installation sizing, consistent with the present disclosure, may include one or more cameras configured to generate a video feed, a user terminal display configured to display the video feed, and one or more distance sensors configured to generate distance data associated with the video feed. The user terminal may be configured to determine a dimension corresponding to an installation region based at least in part on the distance data, receive an indication of one or more pieces of acceptable equipment based, at least in part, on the determined dimension, and overlay an augmented reality element on the video feed corresponding to at least one piece of the one or more pieces of acceptable equipment.

In some instances, the user terminal display may be configured to receive a first touch input and a second touch input while the video feed is being displayed and showing the installation region, the installation region including a first point of interest and a second point of interest, the first and second points of interest corresponding to a respective endpoint of the dimension. In some instances, the first touch input may be associated with a first portion of the distance data and the second touch input is associated with a second portion of the distance data. In some instances, the dimension may be determined based, at least in part, on the first and second portions of the distance data. In some instances, at least one of the first touch input or the second touch input may be adjusted such that both of the first and second touch inputs are within the same horizontal or vertical plane. In some instances, the dimension may be determined after at least one of the first touch input or the second touch input is adjusted. In some instances, the dimension maybe determined during a technician-user session in which the user terminal is communicatively coupled to a technician terminal, the technician terminal and user terminal being configured for bidirectional audio-video communication for at least a portion of the technician-user session. In some instances, during the technician-user session, the augmented reality element may be overlayed on the video feed when the video feed includes the installation region. In some instances, during the technician-user session, an installation date may be scheduled. In some instances, the technician-user session may be recorded for post session viewing.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An installation sizing system comprising:
a user terminal including:
one or more cameras configured to generate a video feed;
a user terminal display configured to display the video feed; and
one or more distance sensors configured to generate distance data associated with the video feed; and
a technician terminal communicatively coupled with the user terminal, the technician terminal and the user terminal being configured to cooperate to determine one or more pieces of acceptable equipment for installation within an installation region, the user terminal being configured to:
determine a dimension corresponding to the installation region based at least in part on the distance data;
transmit the dimension to the technician terminal;
receive an indication of the one or more pieces of acceptable equipment; and
overlay an augmented reality element on the video feed corresponding to at least one piece of the one or more pieces of acceptable equipment.

2. The installation sizing system of claim 1, wherein the user terminal display is configured to receive a first touch input and a second touch input while the video feed is being displayed and showing the installation region, the installation region including a first point of interest and a second point of interest, the first and second points of interest corresponding to a respective endpoint of the dimension.

3. The installation sizing system of claim 2, wherein the first touch input is associated with a first portion of the distance data and the second touch input is associated with a second portion of the distance data.

4. The installation sizing system of claim 3, wherein the dimension is determined based, at least in part, on the first and second portions of the distance data.

5. The installation sizing system of claim 4, wherein at least one of the first touch input or the second touch input is adjusted such that both of the first and second touch inputs are within the same horizontal or vertical plane.

6. The installation sizing system of claim 5, wherein the dimension is determined after at least one of the first touch input or the second touch input is adjusted.

7. The installation sizing system of claim 1, wherein the dimension is determined during a technician-user session in which the user terminal and the technician terminal are configured for bidirectional audio-video communication for at least a portion of the technician-user session.

8. The installation sizing system of claim 7, wherein, during the technician-user session, the augmented reality element is overlayed on the video feed when the video feed includes the installation region.

9. The installation sizing system of claim 7, wherein, during the technician-user session, an installation date is scheduled.

10. The installation sizing system of claim 7, wherein the technician-user session is recorded for post session viewing.

11. A user terminal for use with installation sizing, the user terminal comprising:
one or more cameras configured to generate a video feed;
a user terminal display configured to display the video feed; and
one or more distance sensors configured to generate distance data associated with the video feed, the user terminal being configured to:
determine a dimension corresponding to an installation region based at least in part on the distance data;
receive an indication of one or more pieces of acceptable equipment based, at least in part, on the determined dimension; and
overlay an augmented reality element on the video feed corresponding to at least one piece of the one or more pieces of acceptable equipment.

12. The user terminal of claim 11, wherein the user terminal display is configured to receive a first touch input and a second touch input while the video feed is being displayed and showing the installation region, the installation region including a first point of interest and a second point of interest, the first and second points of interest corresponding to a respective endpoint of the dimension.

13. The user terminal of claim 12, wherein the first touch input is associated with a first portion of the distance data and the second touch input is associated with a second portion of the distance data.

14. The user terminal of claim 13, wherein the dimension is determined based, at least in part, on the first and second portions of the distance data.

15. The user terminal of claim 14, wherein at least one of the first touch input or the second touch input is adjusted such that both of the first and second touch inputs are within the same horizontal or vertical plane.

16. The user terminal of claim 15, wherein the dimension is determined after at least one of the first touch input or the second touch input is adjusted.

17. The user terminal of claim 11, wherein the dimension is determined during a technician-user session in which the user terminal is communicatively coupled to a technician terminal, the technician terminal and user terminal being configured for bidirectional audio-video communication for at least a portion of the technician-user session.

18. The user terminal of claim 17, wherein, during the technician-user session, the augmented reality element is overlayed on the video feed when the video feed includes the installation region.

19. The user terminal of claim 17, wherein, during the technician-user session, an installation date is scheduled.

20. The user terminal of claim 17, wherein the technician-user session is recorded for post session viewing.
